(19) United States
(12) Patent Application Publication
(10) Pub. No.: US 2008/0167440 A1
(43) Pub. Date: Jul. 10, 2008

(54) Use of copolymerizable sulfonate salts to promote char formation in polyesters and copolyesters

(76) Inventors: Deanna L. Pickel, Jefferson City, TN (US); Marc Alan Strand, Kingsport, TN (US); Gether Irick, Gray, TN (US); Douglas Stephens McWilliams, Kingsport, TN (US); Michael Eugene Donelson, Kingsport, TN (US)

Correspondence Address: BRETT L. NELSON;EASTMAN CHEMICAL COMPANY, 100 NORTH EASTMAN ROAD, KINGSPORT, TN, 37660-5075, US

(21) Appl. No.: 11/651,816

(22) Filed: Jan. 10, 2007

(51) Int. Cl. C08G 63/688

(52) U.S. Cl. 528/294

(57) ABSTRACT

comonomers have been shown to improve flammability characteristics of polyesters and copolyesters. Incorporation of sulfonate containing monomers such as 5-sodiosulfoisophthalic acid significantly decreases the heat release capacity of copolyesters. These comonomers also increase the formation of char as measured by thermogravimetric analysis. The decrease in the heat release capacity and increase in char formation indicates that these compositions may have reduced flammability and thus are useful for producing products have reduced flammability. In particular, it has also been demonstrated that incorporation of as little as 0.1 mole % 5-sodiosulfoisophthalic acid to a polyester or copolyester significantly increases the char formation independent of composition.

### FIELD OF THE INVENTION

The present invention relates to the use of the sulfonate salts of diacids, diesters, and glycols as comonomers in copolyesters to induce char formation, decrease the heat release capacity of the polymer, and thus alter the flame characteristics of polyesters and copolyesters.

### BACKGROUND

Most polymers are inherently flammable materials-due to the organic nature of their composition. When a polymer is exposed to a source of ignition, the temperature of the material may exceed its decomposition temperature. Above this decomposition temperature, the material will begin to degrade and release volatile materials (Price, D.; et al Introduction: Polymer combustion, condensed phase pyrolysis, and smoke formation in Fire Retardant Materials, Horrocks, A. R.; Price, D., Eds.; CRC Press: Boca Raton, Fla., 2001, p 11.). These volatile materials enter the vapor phase of a fire and contribute fuel which propagates the flame.

It is desirable to minimize the amount of volatile materials released from a polymer into the vapor phase. In other words, it is desirable for a maximum amount of material to remain in the condensed phase upon exposure to a fire situation. This is generally accomplished by the formation of a char layer. Char formation is a “condensed-phase mechanism for modifying the combustion process” (Price, D.; Anthony, G.; Carty, P. Introduction: Polymer combustion, condensed phase pyrolysis, and smoke formation in Fire Retardant Materials, Horrocks, A. R.; Price, D., Eds.; CRC Press: Boca Raton, Fla., 2001, p 14.). Char forms a barrier to heat and mass flow, and also reduces the amount of material available to participate in the fire. Char modifies the pyrolysis process by reducing the amount of flammable volatiles evolved in favor of increasing the formation of a barrier between the polymer and the flame.

Char formation is generally measured using thermogravimetric analysis (TGA). TGA is a method in which a material is heated at a given rate under a specific atmosphere (e.g. N₂, air). During this heating process, the mass of the sample is monitored to determine the material's decomposition behavior. Char formation is determined by the amount of the materials remaining at a given temperature. TGA is a widely used tool in the flame retardancy field for the determination of char formation and decomposition behavior.

The ability of a polymeric material to form char depends on its chemical structure. For example, poly(methyl methacrylate) decomposes such that no material remains after burning. On the other hand, poly(ether-imide) is known to be an inherently flame retardant polymer. This is due, in part, to its ability to retain more than 50% of its mass after burning. In addition to char formation, the flammability of a material is also measured by its ignitability, flame spread, rate of heat release, ease of extinction, and smoke and toxic gas evolution (Nelson, G. L. The Changing Nature of Fire Retardancy in Polymers in Fire Retardancy in Polymeric Materials, Grand, A. F.; Wilkie, C. A., Eds.; Marcel Dekker: New York, 2000, p 7). One or more of these properties are generally measured by a variety of flammability tests. Materials must pass certain tests in order to be utilized in a variety of applications (e.g. electronics, transportation vehicles, building and construction).

Predicting how a polymeric material will behave in a variety of flammability tests has been a topic of interest for many years. Many attempts have been made to develop models which equate the behavior of a polymer in a fire environment to its heat release capacity, char formation, rate of heat release, and ignitability (Walters, R. N.; Lyon, R. E. J. Appl. Polym. Sci. 2003, 87, 548; van Krevelen, D. W. Polymer 1975, 16, 615). van Krevelen attempted to predict the degree of flammability of a polymer based on its chemical structure (van Krevelen, D. W. Polymer 1975, 16, 615). He determined that the amount of char and incombustible gases formed during decomposition are good measures of flame resistance. In fact, char formation can be predicted based on the chemical structure of the polymer. He also established that the amount of char formed by a material is related to its oxygen index.

The limiting oxygen index (LOI) [van Krevelen, D. W. Polymer 1975, 16, 615] is defined as the minimum percent of oxygen required to maintain combustion of a material in an oxygen-nitrogen atmosphere. A material is considered flammable if its LOI value is less than 26. Using this information, a model was developed that predicted the char forming tendency of a polymer based on group contributions. In other words, given the structure of a polymer, one can assess its flammability based on the molar contributions of the molecule.

Walters and Lyons have refined the molar group contribution model to determine the heat-release capacity of a given material (Walters, R. N.; Lyon, R. E. J. Appl. Polym. Sci. 2003, 87, 548). The heat-release capacity of a material is not only a direct function of the chemical structure, but also has been shown to correlate well with the heat release rate, an indicator of the flammability of a material. Calculation of the heat release capacity of a variety of polymeric materials indicated a correlation between the heat release capacity and both the LOI and the UL-94 rating. In general, polymers with a heat release capacity below 200 J/g·K are self extinguishing materials, resulting in a V-0 rating by the UL-94 Flammability test (Walters, R. N.; Lyon, R. E. J. Appl. Polym. Sci. 2003, 87, 548). Therefore, as the heat release capacity of a material decreases, its flammability also decreases. The UL94 Flammability Test is used to qualify materials for use in Devices and Appliances. A V-0 rating in this test is the highest attainable rating.

The present invention concerns the unexpected discovery that sulfonate salts increase char formation when incorporated into polyesters and copolyesters. This results in an improvement in the flammability characteristics of the sulfonate salt modified polyester and copolyesters. The polyesters and copolyesters described in this invention are useful in engineering plastics applications which require flame resistance.

### SUMMARY OF THE INVENTION

A first embodiment of the present invention concerns an article of manufacture. The article includes a polyester which comprises diacid residues having at least 50 mole percent terephthalic acid residues, 1,4-cyclohexanedicarboxylic acid residues or a mixture thereof, and 0.1 to 5 mole % of an alkali metal or phosphonium salt of a sulfonated dicarboxylic acid. The polyester also comprises diol residues comprising at least 50 mole percent of ethylene glycol residues, cyclohexanedimethanol residues, or a mixture thereof. In the article, the total of the diacid residues is equal to 100 mole percent and the total of the diol residues is equal to 100 mole percent. Moreover, the polyester has 0.1 to 2 mole % of the alkali metal or phosphonium salt of a sulfonated dicarboxylic acid. Furthermore, the article is selected from the group consisting of a sheet, a film, a multi-layered sheet, a multi-layer film, a laminated article, an injection molded article, an extruded profile, and a thermo-formed article.

Another embodiment concerns a multi-layer article comprising at least one film or sheet wherein the film or sheet is formed from the polyester compound.

Yet another embodiment concerns an injection molded article formed from the polyester compound.

An additional embodiment concerns a method of making an article of manufacture comprising extruding the polyester compound to form the article.

### BRIEF DESCRIPTION OF THE DRAWINGS

FIG. 1 shows the effect of comonomer incorporation on the heat release capacity of the polyester; and

FIG. 2 shows the structures of various sulfonate salt diacids and diesters.

### DETAILED DESCRIPTION OF THE INVENTION

The present invention concerns the use of the sulfonate salts of diacids, diesters, and glycols as comonomers in polyesters and copolyesters to induce char formation, decrease the heat release capacity of the polymer, and thus alter the flame characteristics of copolyesters. Also, the present invention concerns products produced from these polyesters and co-polyesters. Products made from the copolyesters and polyesters of the present invention show minimized flame spread and smoke generation due to the ability of the polyester or copolyester to form an increased char layer when contacted with a flame.

The polyesters and copolyesters of the present invention are useful for making numerous articles of manufacture and products. For example, the polyesters and copolyesters of the present invention are useful for making products where decreased flammability of the product is desired. Examples of such products include sheets, films, multi-layered sheets or films, laminated articles, injection molded articles, extruded profiles such as a multiwall sheet, and thermo-formed articles. For the purpose of this invention and as generally recognized in the art, a film can be an extruded film and is generally considered to have a thickness of about 40 mils (0.040 inches) or less. A sheet can also be extruded, and is generally considered to have a thickness of about 40 mils (0.040 inches) or more. For example, a sheet can have a thickness of about 40 mils (0.040 inches) to about 500 mils (0.5 inches). A multiwall sheet is an extruded profile consisting of two or more layers connected together by fillets to produce a lightweight architectural glazing.

A non-exhaustive list of film products according to the present invention includes wall coverings (e.g. wall paper, laminated sheet), furniture materials (e.g. coverings, laminated formed objects), molded furniture (e.g. chairs, tables), electronic materials (e.g. computer housings, communication housings), marine use materials (e.g. furniture for boats, interior paneling), roofing (e.g. film underlayment), flooring (e.g. underlayment for flooring), building assemblies (e.g. trim, framing), door assemblies (e.g. door frames, doors, door trim), window assemblies (e.g. window frames and trim), signs, transportation assemblies (e.g. furniture and wall coverings for automotive and mass transportation, shipping containers), manufactured housing assemblies (e.g. mobile homes, underlayment for flooring, wall coverings, furniture, doors, trim), air-handling assemblies (e.g. vents, piping), and decorative products (e.g. wall covering, laminated thermoformed objects).

A non-exhaustive list of sheet and multi-layer sheet products according to the present invention includes wall coverings (e.g. wall paper, laminated sheet), bus shelters (e.g. sheet enclosures), furniture materials (e.g. coverings, laminated formed objects), molded furniture (e.g. chairs, tables), electronic materials (e.g. computer housings, communication housings), marine use materials (e.g. furniture for boats, interior paneling), roofing (e.g. film underlayment), flooring (e.g. underlayment for flooring), building assemblies (e.g. trim, framing), door assemblies (e.g. door frames, doors, door trim), window assemblies (e.g. window frames and trim), signs, transportation assemblies (e.g. furniture and wall coverings for automotive and mass transportation, shipping containers), manufactured housing assemblies (e.g. mobile homes, underlayment for flooring, wall coverings, furniture, doors, trim), air-handling assemblies (e.g. vents, piping), and decorative products (e.g. wall covering, laminated thermoformed objects).

The multilayer products listed in the previous paragraphs can be constructed of multiple films, sheets, or a combination of both.

A non-exhaustive list of multiwall products according to the present invention includes glazing for carports, roof coverings, conservatories, greenhouses, swimming pool enclosures, sports arenas, signs, and displays.

A non-exhaustive list of injection molded products according to the present invention includes profiles, furniture materials, molded furniture, electronic materials, roofing, flooring, building assemblies, door assemblies, window assemblies, molding, signs, transportation assemblies, manufactured housing assemblies, and decorative products. See above for examples.

The term “polyester” means a synthetic polymer prepared by the polycondensation of dicarboxylic acids with dihydric alcohols. The term copolyester means a polyester containing two or more types of basic repeating units. The term “residue”, as used herein, means any repeating organic structure incorporated into the polymer through a polycondensation reaction. Thus, the dicarboxylic acid residue may be derived from a dicarboxylic acid or its associated esters, salts, anhydrides, or mixtures thereof. As used herein, therefore, the term dicarboxylic acid is intended to include dicarboxylic acids and any derivative of a dicarboxylic acid, including its associated esters, half-esters, salts, half-salts, acid halides, anhydrides, mixed anhydrides, or mixtures thereof, useful in a polycondensation process with a diol to make a high molecular weight polyester. One or more dicarboxylic acids may be used. The dicarboxylic acid component, a total of 100 mole %, may comprise about 60 to 100 mole % of a first dicarboxylic acid residue from the residues of terephthalic acid, naphthalenedicarboxylic acids, cyclohexanedicarboxylic acids, or mixtures thereof. Preferably the first dicarboxylic acid residue will comprise about 80 to 100 mole % and, more preferably, from about 90 to 100 mole % of the dicarboxylic acid residues. Examples of naphthalenedicarboxylic acids with may be used in our invention include 1,2-naphthalenedicarboxylic acid, 1,3-naphthalenedicarboxylic acid, 1,4-naphthalenedicarboxylic acid, 1,5-naphthalenedicarboxylic acid, 1,6-naphthalenedicarboxylic acid, 2,4-naphthalenedicarboxylic acid, 2,5-naphthalenedicarboxylic acid, 2,6-naphthalenedicarboxylic acid, 2,7-naphthalenedicarboxylic acid, 2,8-naphthalenedicarboxylic acid, their associated esters, or mixtures thereof. Examples of cyclohexanedicarboxylic acids are 1,2-cyclohexanedicarboxylic acid, 1,3-cyclohexanedicarboxylic acid, and 1,4-cyclohexanedicarboxylic acid. The cycloaliphatic acids, for example, 1,3- and 1,4-cyclohexanedicarboxylic acids, may be present as their pure cis or trans isomers or as a mixture of cis and trans isomers.

The polyester may be modified with from 0 to about 40 mole % of a second dicarboxylic acid residue comprising residues from aromatic dicarboxylic acids containing from about 8 to about 16 carbon atoms, aliphatic dicarboxylic acids containing about 4 to about 16 carbon atoms, cycloaliphatic dicarboxylic acids containing from about 6 to about 16 carbon atoms, or mixtures thereof. Non-limiting examples of modifying dicarboxylic acids are fumaric, succinic, adipic, glutaric, azelaic, sebacic, isophthalic, resorcinoldiacetic, 1,2-cyclobutanedicarboxylic acid, 1,3-cyclobutanedicarboxylic acid, 2,2,4,4-tetramethyl-1,3-cyclobutanedicarboxylic acid, 1,3-cyclopentanedicarboxylic acid, diglycolic, 4,4′-oxybis[benzoic], biphenyldicarboxylic, 4,4′-methylenedibenzoic, trans-4,4′-stilbenedicarboxylic, and sulfoisophthalic acids.

The diol residues comprise about 50 to 100 mole % of a first diol residue selected from 1,3-cyclohexanedimethanol, 1,4-cyclohexanedimethanol, 1,3-propanediol, and mixtures thereof; and from 0 to about 50 mole % of a second diol residue selected from aliphatic diols containing from 2 to about 16 carbon atoms, cycloaliphatic diols containing from about 6 to about 16 carbon atoms, and mixtures thereof. Preferably, the first diol residue may comprise about 70 to 100 mole % or, more preferably, from about 90 to 100 mole % of the diol residues. The cycloaliphatic diols, for example, 1,3- and 1,4-cyclohexanedimethanol, may be present as their pure cis or trans isomers or as a mixture of cis and trans isomers. As used herein, the term “diol” is synonymous with the term “glycol” and means any dihydric alcohol. Non-limiting examples of second diol residue are residues from ethylene glycol, neopentyl glycol, 1,3-propanediol, 1,4-butanediol, 1,5-pentanediol, 1,6-hexanediol, 2,2-dimethyl-1,3-propanediol, 1,8-octanediol, 1,10-decanediol, diethylene glycol, and 2,2,4,4-tetramethyl-1,3-cyclobutanediol.

Alkali metal sulfonate salts useful in the present invention include alkali metal sulfonate salts of diacids, diesters, and glycols as comonomers.

Examples of alkali metal sulfonate salts of diacids include alkali metal salts of sulfonated isophthalic acid (e.g. 5-sodiosulfoisophthalic acid), alkali metal salts of sulfonated phenoxyisophthalic acid (e.g. 5-[p-(sodiosulfo)phenoxy] isophthalic acid), tetra-alkyl phosphonium salts of sulfonated isophthalic acid (e.g. 5-tetra-n-butylphosphonium sulfoisophthalic acid), tetra-alkyl phosphonium salts of sulfonated phenoxyisophthalic acid (e.g. 5-[p-(tetra-n-butylphosphonium sulfo)phenoxy]isophthalic acid), and 3-sodiosulfophenyl-3,5-dicarbomethoxy-benzenesulfonate.

Examples of alkali metal sulfonate salts of diesters include alkali metal salts of sulfonated dimethyl isophthalate (e.g. dimethyl 5-sodiosulfoisophthalate), alkali metal salts of sulfonated phenoxyisophthalic acid (e.g. dimethyl 5-[p-(sodiosulfo)phenoxy]isophthalate), tetra-alkyl phosphonium salts of sulfonated dimethyl isophthalate (e.g. dimethyl 5-tetra-n-butylphosphonium sulfoisophthalate), tetra-alkyl phosphonium salts of sulfonated dimethyl phenoxyisophthalate (e.g. dimethyl 5-[p-(tetra-n-butyl phosphonium sulfo)phenoxy] isophthalate), 4-sodiosulfophenyl-3,5-dicarbomethoxy-benzenesulfonate, 4-lithiosulfophenyl-3,5-dicarboxymethoxybenzenesulfonate, 4-sodiosulfo-2,6-dimethyl phenyl-3,5-dicarbomethoxybenzenesulfonate, 4-sodiosulfo-2,6-dipropylphenyl-3,5-dicarbomethoxybezenesulfonate, 4-sodio-1-naphthyl-3,5-dicarbomethoxybenzenesulfonate, 5-sodio-1-naphthyl-3,5-dicarbomethoxybenzenesulfonate, sodiosulfo-1-naphthyl-3,5-dicarbomethoxy-benzene, 4-sodiosulfophenyl-3,5-dicarbethoxybenzenesulfonate, sodiosulfophenyl-3,5-dicarbopropoxybenzenesulfonate, sodiosulfophenyl-3,5-dicarbobutoxybenzenesulfonate, 4-sodiosulfophenyl-3,4-dicarbomethoxybenzenesulfonate, 4-sodiosulfophenyl-2,5-dicarbomethoxybenzenesulfonate, 2-sodiosulfophenyl-3,5-dicarbomethoxybenzenesulfonate, 4-postassiosulfophenyl-3,5-dicarbomethoxybenzenesulfonate, 7-sodiosulfo-1-naphthyl-3,5-dicarbomethoxybenzenesulfonate, 8-sodiosulfo-1-naphthyl-3,5-dicarbomethoxybenzenesulfonate, and 6-sodiosulfo-2-naphthyl-3,5-dicarbomethoxybenzenesulfonate.

Examples of difunctional sulfo-monomer components which are hydroxylcarboxylic acid derivatives or glycol derivatives include:

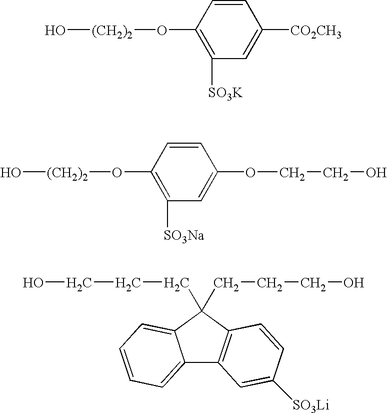

The polyesters include linear, thermoplastic, crystalline or amorphous polyesters produced by conventional polymerization techniques from one or more diols and one or more dicarboxylic acids or ester-forming equivalent thereof such as a dicarboxylate ester and one or more alkali metal or phosphonium salt of a sulfonated dicarboxylic acid. The polyesters normally having an inherent viscosity (I.V.) of about 0.4 to about 1.2 dL/g measured at 25° C. in a 60/40 ratio by weight of phenol/tetrachloroethane. Typical polyesters comprise:
(1) diacid residues comprising at least 50 mole percent terephthalic acid residues, 1,4-cyclohexanedicarboxylic acid residues or a mixture thereof; and 0.1 to 5 mole % of an alkali metal or phosphonium salt of a sulfonated dicarboxylic acid and
(2) diol residues comprising at least 50 mole percent of ethylene glycol residues, cyclohexanedimethanol residues, or a mixture thereof;
   wherein the total of the diacid residues is equal to 100 mole percent and the total of the diol residues also is equal to 100 mole percent. The polyesters typically contain up to about 200 ppm of metal impurity, e.g., 10 to 200 ppm Ti, Co and/or Mn residues.

The diol residues of the polyesters may be derived from one or more of the following diols: 2,6-decahydronaphthalenedimethanol, ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-, 1,3- and 1,4-cyclohexanedimethanol, 2,2,4,4-tetramethyl-1,3-cyclobutanediol, bis[4-(2-hydroxyethoxy)phenyl]sulfone, 1,4:3,6-dianhydro-sorbitol, 4,4′-iso-propyl idenedicyclohexanol, Z-8-bis(hydroxymethyl)-tricyclo-[5.2.1.0]-decane wherein Z represents 3, 4, or 5; and diols containing one or more oxygen atoms in the chain, e.g., diethylene glycol, triethylene glycol, dipropylene glycol, tripropylene glycol and the like. In general, these diols contain 2 to 18, preferably 2 to 8 carbon atoms. Cycloaliphatic diols can be employed in their cis or trans configuration or as mixtures of both forms.

The diacid residues of the polyesters may be derived from a variety of aliphatic, alicyclic, and aromatic dicarboxylic acids. Examples of the dicarboxylic acids from which the diacid residues may be obtained include 2,6-decahydronaphthalenedicarboxylic acid, terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid and the like. The diacid residues may be obtained from the dicarboxylic acid or ester forming derivatives thereof such as esters of the dicarboxylic acid, e.g., dimethyl dicarboxylate esters, acid halides and, in some cases, anhydrides.

The difunctional sulfo-monomer component of the polyester may be a dicarboxylic acid or an ester thereof containing a metal sulfonate group or a glycol containing a metal sulfonate group or a hydroxyl acid containing metal sulfonate group. The metal ion of the sulfonate salt may be Na⁺, Li⁺, K⁺, Mg⁺⁺, Ca⁺⁺, and the like. Advantageous examples of difunctional sulfo-monomer components are those wherein the sulfonate salt group is attached to an aromatic acid nucleus such as a benzene, naphthalene, diphenyl, oxydiphenyl, sulfonyldiphenyl, or methylenediphenyl nucleus. Preferred results are obtained through the use of sulfophthalic acid, sulfoterephthalic acid, sulfoisophthalic acid, 4-sulfonaphthalene-2,7-dicarboxylic acid, and their esters; metallosulfoaryl sulfonate (as described in Lappin, Kibler, Gilmer, and Jones U.S. patent application Ser. No 695,349, entitled “New Organic Compounds and Basic Dyeable Polyesters Containing Same” filed Jan. 3, 1968).

One or more branching agents also may be useful in making the polyesters formed within the context of the invention. Although not required, it is preferred that the optional branching agent is present in the polyesters in an amount of less than 5 mole percent wherein the total mole percent of the dicarboxylic acid component equals 100 mole percent and the total mole percent of the diol component equals 100 mole %. The branching agent may provide branching in the acid unit portion of the polyester, or in the glycol unit portion, or it can be a hybrid. Some of these branching agents have already been described herein. However, illustrative of such branching agents are polyfunctional acids, polyfunctional glycols and acid/glycol hybrids. Examples include tri- or tetra-carboxylic acids, such as trimesic acid, pyromellitic acid and lower alkyl esters thereof and the like, and tetrols such as pentaerythritol. Also triols such as trimethylopropane or dihydroxy carboxylic acids and hydroxydicarboxylic acids and derivatives, such as dimethyl hydroxy terephthalate, and the like are useful within the context of this invention. Trimellitic anhydride is a preferred branching agent. The branching agents may be used either to branch the polyester itself or to branch the polyester/polycarbonate blend of the invention.

It is preferred that the polyester comprise about 30 to 100 mole percent 1,4-cyclohexanedimethanol residues wherein the total mole percentages of diol residues of the polyester equals 100 mole percent. In this embodiment, it is also preferred that the polyester comprises 0 to about 70 mole percent ethylene glycol residues. While the diacid residues present in this embodiment may be derived from any diacid, it is preferred that the diacid residues comprise terephthalic acid, isophthalic acid and/or 1,4-cyclohexanedicarboxylic acid residues, and about 0.1 to 5 mole percent of an alkali metal or phosphonium salt of a sulfonated dicarboxylic acid. When terephthalic acid residues are present, the polyester comprises about 65 to 99.9 mole percent terephthalic acid residues and about 0 to 35 mole percent isophthalic acid residues.

One group of preferred polyesters have an inherent viscosity of about 0.4 to 1.2, preferably 0.4 to 0.8, dL/g measured at 25° C. in a 60/40 ratio by weight of phenol/tetrachloroethane and comprise:
(1) diacid residues comprising about 80 to 99.9 mole percent terephthalic acid residues and about 0 to 20 mole percent isophthalic acid residues and 0.1 to 5 mole percent of an alkali metal or phosphonium salt of a sulfonated dicarboxylic acid; and
(2) diol residues comprising about 40 to 100 mole percent, preferably 55 to 80 mole percent, 1,4-cyclohexanedimethanol residues and 0 to about 60 mole percent, preferably about 20 to 45 mole percent of ethylene glycol residues,
   wherein the total of the diacid residues is equal to 100 mole percent and the total of the diol residues also is equal to 100 mole percent.

Another group of preferred polyesters have an inherent viscosity of about 0.4 to 1.2, preferably about 0.4 to 0.8, dL/g measured at 25° C. in a 60/40 ratio by weight of phenol/tetrachloroethane and comprise:
(1) diacid residues comprising about 65 to 83 mole percent, preferably about 70 to 80 mole percent, terephthalic acid residues and about 35 to 17 mole percent, preferably 30 to 20 mole percent, isophthalic acid residues and 0.1 to 5 mole percent of an alkali metal or phosphonium salt of a sulfonated dicarboxylic acid; and
(2) diol residues comprising about 80 to 100 mole percent, preferably 90 to 100 mole percent, 1,4-cyclohexanedimethanol residues and about 0 to about 20 mole percent, preferably 0 to 10 mole percent, ethylene glycol residues;
   wherein the total of the diacid residues is equal to 100 mole percent and the total of the diol residues also is equal to 100 mole percent.

In yet another preferred embodiment, the polyesters have an inherent viscosity of about 0.4 to 1.2, preferably about 0.4 to 0.8 dL/g measured at 25° C. in a 60/40 ratio by weight of phenol/tetrachloroethane and comprise:
(1) diacid residues comprising about 80 to 99.9 mole percent, more preferably 90 to 100 mole percent terephthalic acid residues and about 0 to 20 mole percent, more preferably 0 to 10 mole percent isophthalic acid residues and 0.1 to 5 mole percent of an alkali metal or phosphonium salt of a sulfonated dicarboxylic acid; and
(2) diol residues comprising about 25 to 37 mole percent, preferably 28 to 34 mole percent, 1,4-cyclohexanedimethanol residues and about 75 to about 63 mole percent, preferably about 72 to 66 mole percent, ethylene glycol residues;
   wherein the total of the diacid residues is equal to 100 mole percent and the total of the diol residues also is equal to 100 mole percent.

The linear polyesters may be prepared according to polyester-forming procedures and conditions well known in the art. For example, a mixture of one or more dicarboxylic acids, preferably aromatic dicarboxylic acids, or ester forming derivatives thereof, and one or more diols may be heated in the presence of an esterification catalyst and/or polyesterification catalysts at temperatures in the range of about 150 to about 300° C. and pressures in the range of from of atmospheric to about 0.2 Torr. Normally, the dicarboxylic acid or derivative thereof is esterified or transesterified with the diol(s) at atmospheric pressure and at a temperature at the lower end of the specified range. Polycondensation then is affected by increasing the temperature and lowering the pressure while excess diol is removed from the mixture. A preferred temperature range for a polyester condensation is about 260 to about 300° C.

Typical catalyst or catalyst systems for polyester condensation are well known in the art. For example, the catalysts disclosed in U.S. Pat. Nos. 4,025,492; 4,136,089; 4,176,224; 4,238,593; and 4,208,527, incorporated herein by reference, are deemed suitable in this regard. Further, R. E. Wilfong, Journal of Polymer Science, 54 385 (1961) sets forth typical catalysts which are useful in polyester condensation reactions. The most preferred catalysts are complexes of titanium, manganese and cobalt. It is understood that phosphorus-containing molecules can be added in addition to metal catalysts. Polymer compositions that employ antimony or its metal complexes as a catalyst may become unsuitably darkened by adding a phosphorus-containing molecule, such as phosphorous acid or salts of phosphorous acid, e.g., the salts of component (B) of the present invention, during melt blending and extruding.

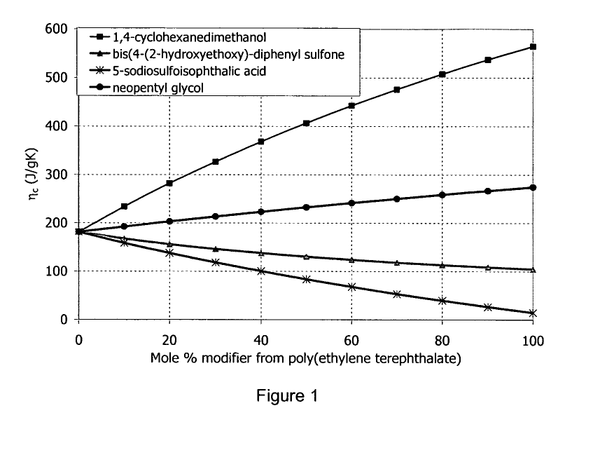

Application of the molar group contribution model to a variety of copolyesters over a variety of compositions indicates that traditional copolyesters are inherently flammable materials as shown in FIG. 1. These calculations are based on poly(ethylene terephthalate) modified with a variety of comonomers. As discussed above, a heat release capacity below 200 J/g·K indicates self extinguishing behavior (Walters, R. N.; Lyon, R. E. J. Appl. Polym. Sci. 2003, 87, 548). As shown in the examples below, incorporation of a sulfonate salt (such as 5-sodiosulfoisophthalic acid, a sulfur containing comonomer) decreased the heat release capacity dramatically, even at low loadings. The opposite effect was seen when 1,4-cyclohexanedimethanol or neopentyl glycol are incorporated into poly(ethylene terephthalate). Therefore, polymers containing sulfone or sulfonate groups can provide a route to inherently flame retardant polyesters and copolyesters by reduction of the heat release capacity.

Utilizing the group contribution models developed by Walters and Lyons, the present inventors have demonstrated that incorporation of a sulfonate salt into a polyester or copolyester significantly decreases the heat release capacity. It has also been demonstrated that modification of copolyesters with as little as 0.1 mole % of a sulfonate salt increases formation of char at 600° C. as measured by thermogravimetric analysis. This behavior applies to a variety of compositions, provided the polyester of copolyester contains an aromatic component. An increase in char formation is one of the key factors which contributes to the flammability of a polymeric substance. An increase in the tendency to form char implies a decrease in a material's flammability (van Krevelen, D. W. Polymer 1975, 16, 615).

### EXAMPLES

The inherent viscosity of the polyester was determined in 60/40 (wt/wt) phenol/tetrachloroethane at a concentration of 0.5 g/100 ml at 25° C. in a capillary viscometer. The glass transition temperature (T_{g}) was determined using a TA 2100 Thermogravimetric Analyzer from Thermal Analyst Instrument at a scan rate of 20° C./min. Char formation was determined using a TA Instruments Model 2950 Thermogravimetric Analyzer. Approximately 10 mg of the material is placed in the sample holder and is heated under nitrogen while scanning from 300 to 600° C. at 20° C./minute. From the thermogram, the temperature at 10% weight loss and the weight % remaining at 600° C. were obtained. The limiting oxygen index (LOI) is used to determine the minimum concentration of oxygen in a flowing mixture of oxygen and nitrogen that will just support flaming combustion of a material. [ASTM D2863]. A specimen is clamped at the bottom and held vertically in a glass test column. A known concentration of oxygen in an oxygen and nitrogen mixture flows up into the column. The specimen is ignited from the top. To be classified as a burn, the specimen must either burn for a minimum of three minutes or burn 50 mm down the length axis. Failure to meet one of these criteria is classified as a non-burn. This minimum concentration is reported as the Oxygen Index (LOI).

### Example 1

This example illustrates the preparation of a copolyester containing 99 mole % terephthalic acid, 1 mole % 5-sodiosulfoisophthalic acid, and 100 mole % ethylene glycol.

A mixture of 66.12 g (0.495 mol) dimethyl terephthalate, 1.34 g 5-sodiosulfoisophthalic acid (0.005 mol), 62.07 g of ethylene glycol (1.0 mole), and 100 ppm Ti in the form of titanium tetraisopropoxide was placed in a 500 milliliter flask equipped with an inlet for nitrogen, a metal stirrer, and a short distillation column. The flask was placed in a metal bath heated to 200° C. and the contents of the flask were heated at 185° C. for 2 hours, then at 200° C. for 2 hours, then heated up to 250° C. in 5 minutes. Once at 250° C., a vacuum of 100 mm Hg was gradually applied over the next hour. Once reaching 100 mm Hg, the temperature was increased to 270° C. and a vacuum of 0.45 mm Hg was applied over 5 minutes. Full vacuum was maintained for a total time of about 120 minutes to remove excess unreacted diol. A high melt viscosity polymer was obtained with a glass transition temperature of 77° C. and an inherent viscosity of 0.77 dl/g.

### Example 2

This example illustrates that 5-sodiosulfoisophthalic acid unexpectedly promotes char formation in copolyesters.

Poly(ethylene terephthalate)s modified with increasing amounts of 5-sodiosulfoisophthalic acid (NaSIPA) were prepared in a method similar to that described in Example 1. These copolyesters were all made with 100 ppm titanium in the form of titanium tetraisopropoxide as the catalyst. Char formation was analyzed by thermogravimetric analysis (TGA) at 600° C. Samples were heated at a rate of 20° C./min in a TGA under a nitrogen flow of 50 cc/min. Char data is shown in Table 1. The thermal data indicates that at low modifications of 5-sodiosulfoisophthalic acid, a large enhancement in char is observed. For example, a 0.4 mole % modification of poly(ethylene terephthalate) with 5-sodiosulfoisophthalic acid resulted in a 66% increase in char at 600° C. Addition of 5-sodiosulfoisophthalic acid also decreased the temperature at 10% loss.

TABLE 1
Char formation of polyethylene terephthalate modified with 5-
sodiosulfoisophthalic acid.

| mole % | | Temp at | Char at | |
|---|---|---|---|---|
| 5-sodiosulfoisophthalic | lhV | 10% Loss | 600° C. | T_{g} |
| acid | (dl/g) | (° C.) | (wt %) | (° C.)^{a} |
| 0 | — | 418 | 10.0 | — |
| 0.1 | 0.71 | 410 | 16.2 | 83.4 |
| 0.4 | 0.75 | 410 | 16.6 | 81.2 |
| 0.9 | 0.77 | 401 | 18.7 | 76.5 |
| 2.5 | 0.71 | 408 | 18.2 | 70.6 |
| 4.6 | 0.64 | 403 | 19.3 | 64.3 |

^{a}T_{g} determined by Differential Scanning Calorimetry second heating cycle

### Example 3

This example illustrates the preparation of a copolyester containing 99 mole % terephthalic acid, 1 mole % 5-sodiosulfoisophthalic acid, 62 mole % ethylene glycol and 12 mole % 1,4-cyclohexanedimethanol.

A mixture of 96 g (0.495 mol) dimethyl terephthalate, 1.48 g 5-sodium sulfoisophthalic acid (0.005 mol), 58.2 g of ethylene glycol (0.938 mol), 8.90 g 1,4-cyclohexanedimethanol (0.062 mol), 46 ppm Mn in the form of manganese acetate, 23 ppm P in the form of a phosphate ester and 32 ppm Ti in the form of titanium tetraisopropoxide was placed in a 500 milliliter flask equipped with an inlet for nitrogen, a metal stirrer, and a short distillation column. The flask was placed in a Wood's metal bath heated to 200° C. and the contents of the flask were heated at 185° C. for 2 hours, then at 200° C. for 2 hours, then heated up to 250° C. in 5 minutes. Once at 250° C., a vacuum of 100 mm Hg was gradually applied over the next hour. Once reaching 100 mm Hg, the temperature was increased to 270° C. and a vacuum of 0.45 mm Hg was applied over 5 minutes. Full vacuum was maintained for a total time of about 120 minutes to remove excess unreacted diol. A high melt viscosity polymer was obtained with an inherent viscosity of 0.69 dl/g.

### Example 4

This example illustrates that 5-sodiosulfoisophthalic acid unexpectedly promotes char formation in 1,4-cyclohexanedimethanol containing copolyesters.

Copolyesters containing increasing amounts of 5-sodiosulfoisophthalic acid were prepared in a method similar to that described in Example 3. Char formation was analyzed by thermogravimetric analysis (TGA) at 600° C. Samples were heated at a rate of 20° C./min in a TGA under a nitrogen flow of 50 cc/min. Char data is shown in Table 2. The thermal data demonstrates that modification with 1,4-cyclohexanedimethanol dramatically decreases char formation, as predicted by the group contribution model. Incorporation of 1 mole % 5-sodiosulfoisophthalic acid increased char formation by greater than 75% depending on the composition.

TABLE 2
Char formation of 5-sodiosulfoisophthalic acid modified
poly(ethylene-co-1,4-cyclohexanedimethyl) terephthalate.

| mole % | | mole % | | | Temp at | Wt % |
|---|---|---|---|---|---|---|
| terephthalic | mole % | ethylene | mole % 1,4- | | 10% | at 600 |
| acid | NaSIPA | glycol | cyclohexanedimethanol | LOI | Loss | (° C.) |
| 100 | 0 | 88 | 12 | 32 | 417.9 | 8.5 |
| 99 | 1 | 88 | 12 | 34.4 | 417.8 | 14.9 |
| 100 | 0 | 38 | 62 | 25.5 | 408.3 | 1.9 |
| 99 | 1 | 38 | 62 | 26.3 | 405.5 | 4.5 |

### Example 5

This example illustrates that modification of copolyesters with 5-sodiosulfoisophthalic acid increases the limiting oxygen index.

Copolyesters containing increasing amounts of 5-sodiosulfoisophthalic acid were prepared in a method similar to that described in Example 3. The limiting oxygen index of each copolyester was determined and the results are shown in Table 2. Incorporation of 5-sodiosulfosophthalic acid increases the LOI of copolyesters containing both moderate and high levels of 1,4-cyclohexanedimethanol.

### Example 6

This example illustrates that formation of char in copolyesters is independent of the cation of the sulfoisophthalic acid incorporated into the polyester.

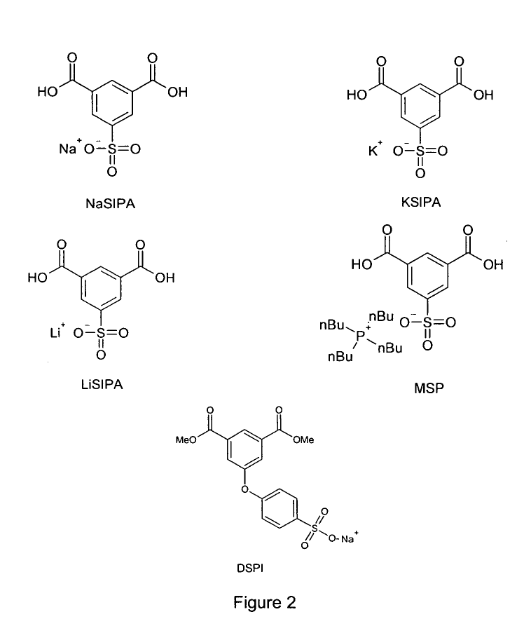

A variety of copolyesters were prepared as described in Example 1 utilizing different sulfoisopthalic acids as shown in FIG. 2. Char formation was analyzed by thermogravimetric analysis (TGA) at 600° C. Samples were heated at a rate of 20° C./min in a TGA under a nitrogen flow (50 cc/min). Char data is shown in Table 3. Incorporation of 5-tetra-n-butylphosphonium sulfoisophthalic acid (MSP) into PET slightly increases char formation, but not to the extent of NaSIPA (see Table 3). For a given level of the sulfonate salt, substitution of NaSIPA with the potassium salt of 5-sulfoisophthalic acid (KSIPA) resulted in an increase in char formation, while substitution of NaSIPA with the lithium salt of 5-sulfoisophthalic acid (LiSIPA) decreased char formation. The char level plateaus at 20 wt % for all of the monomers, independent of the counterion.

TABLE 3
Effect of counterion of 5-sulfoisophthalic acid on char formation.

| | | | Char at |
|---|---|---|---|
| | | Temp at | 600° C. |
| Mole % Modifier | IV | 10% Loss | (wt %) |
| 0% Modifier | — | 418 | 10.0 |
| 0.1% NaSIPA | 0.71 | 410 | 16.2 |
| 0.4% NaSIPA | 0.75 | 410 | 16.6 |
| 0.9% NaSIPA | 0.77 | 401 | 18.7 |
| 2.5% NaSIPA | 0.71 | 408 | 18.2 |
| 4.6% NaSIPA | 0.64 | 403 | 19.3 |
| 0.1% LiSIPA | 0.793 | 410 | 15.7 |
| 0.5% LiSIPA | 0.681 | 406 | 16.7 |
| 1.0% LiSIPA | 0.807 | 407 | 16.5 |
| 2.8% LiSIPA | 0.725 | 405 | 19.3 |
| 9.2% LiSIPA | 0.346 | 384 | 16.3 |
| 13.4% LiSIPA | 0.327 | 376 | 18.7 |
| 0.3% KSIPA | 0.634 | 412 | 15.7 |
| 0.8% KSIPA | 0.755 | 411 | 19.6 |
| 0.9% KSIPA | 0.619 | 411 | 19.9 |
| 2.8% KSIPA | 0.515 | 408 | 20.1 |
| 4.6% KSIPA | 0.458 | 408 | 20.2 |
| 1% MSP | 0.731 | 406 | 14.3 |
| 4.8% MSP | 0.643 | 402 | 19.9 |
| 9.8% MSP | 0.563 | 398 | 19.6 |
| 0.4% DCBS | 0.607 | 406 | 17.3 |
| 0.9% DCBS | 0.651 | 406 | 18.4 |

### Example 7

This example illustrates that the char enhancing capabilities are not limited to sulfonate salts of isophthalic acid. Other diacids and diesters containing sulfonate salts increase char formation.

A variety of copolyesters were prepared as described in Example 1 utilizing increasing amounts of dimethyl 5-[p-(sodiosulfo)phenoxy]isophthalate (DSPI). Char formation was analyzed by thermogravimetric analysis (TGA) at 600° C. Samples were heated at a rate of 20° C./min in a TGA under a nitrogen flow (50 cc/min). Char data is shown in Table 4. The increase in char formation upon incorporation of DSPI into PET is comparable to that seen with NaSIPA (see Table 3).

TABLE 4
Effect of DCBS on char formation.

| | | | Char at |
|---|---|---|---|
| | | Temp at | 600° C. |
| Mole % DSPI | IV | 10% Loss | (wt %) |
| 0 | — | 418 | 10.0 |
| 0.4 | 0.607 | 406 | 17.3 |
| 0.9 | 0.651 | 406 | 18.4 |

The invention has been described in detail with particular reference to preferred embodiments thereof, but it will be understood that variations and modifications can be effected within the spirit and scope of the invention.

1. An article of manufacture, comprising:
a polyester comprising:
(1a) diacid residues having at least 50 mole percent terephthalic acid residues, 1,4-cyclohexanedicarboxylic acid residues or a mixture thereof; and
(1b) 0.1 to 5 mole % of an alkali metal or phosphonium salt of a sulfonated dicarboxylic acid; and
(2) diol residues comprising at least 50 mole percent of ethylene glycol residues, cyclohexanedimethanol residues, or a mixture thereof;
wherein the total of the diacid residues is equal to 100 mole percent and the total of the diol residues is equal to 100 mole percent,
the polyester has 0.1 to 2 mole % of the alkali metal or phosphonium salt of a sulfonated dicarboxylic acid,
the article forms char at 600° C. of from 15.7 weight percent to 20.2 weight percent, and
the article is selected from the group consisting of a sheet, a film, a multi-layered sheet, a multi-layer film, a laminated article, an injection molded article, an extruded profile, and a thermo-formed article.

2. The article according to claim 1, wherein the article is a film.

3. The article according to claim 1, wherein the article is a sheet.

4. The article according to claim 1, wherein the extruded profile is a multiwall sheet selected from the group consisting of glazing for carports, roof coverings, conservatories, greenhouses, swimming pool enclosures, sports arenas, signs, and displays.

5. A multi-layer article comprising at least one film or sheet wherein said film or sheet is formed from a polyester, comprising:
(1a) diacid residues having at least 50 mole percent terephthalic acid residues, 1,4-cyclohexanedicarboxylic acid residues or a mixture thereof; and
(1b) 0.1 to 5 mole % of an alkali metal or phosphonium salt of a sulfonated dicarboxylic acid; and
(2) diol residues comprising at least 50 mole percent of ethylene glycol residues, cyclohexanedimethanol residues, or a mixture thereof;
wherein the total of the diacid residues is equal to 100 mole percent and the total of the diol residues is equal to 100 mole percent, and
the article forms char at 600° C. of from 15.7 weight percent to 20.2 weight percent.

6. The multilayer article according to claim 5, wherein said article is selected from the group consisting of a wall covering, a bus shelter, furniture material, molded furniture, electronic material, marine use material, roofing, flooring, a building assembly, a door assembly, a window assembly, a sign, a transportation assembly, a manufactured housing assembly, a air-handling assembly, and a decorative product.

7. An injection molded article formed from a polyester, comprising:
(1a) diacid residues having at least 50 mole percent terephthalic acid residues, 1,4-cyclohexanedicarboxylic acid residues or a mixture thereof; and
(1b) 0.1 to 5 mole % of an alkali metal or phosphonium salt of a sulfonated dicarboxylic acid; and
(2) diol residues comprising at least 50 mole percent of ethylene glycol residues, cyclohexanedimethanol residues, or a mixture thereof;
wherein the total of the diacid residues is equal to 100 mole percent and the total of the diol residues is equal to 100 mole percent, and
the article forms char at 600° C. of from 15.7 weight percent to 20.2 weight percent.

8. The article according to claim 7, wherein the article is selected from the group consisting of molded furniture, roofing, flooring, a door assembly, a window assembly, molding, a sign, and decorative products.

9. A method of making an article of manufacture according to claim 1, comprising extruding the polyester to form said article.

10. A method of making an article of manufacture according to claim 1, comprising injection molding the polyester to form said article.
